(19) United States
(12) Patent Application Publication
(10) Pub. No.: US 2010/0052862 A1
(43) Pub. Date: Mar. 4, 2010

(54) METHOD FOR PREVENTING SIGNAL COLLISION IN RADIO FREQUENCY IDENTIFICATION SYSTEM AND RADIO FREQUENCY IDENTIFICATION TAG USED THEREOF

(75) Inventors: Yuan-Ning Hsieh, Hsinchu (TW); Ta-Yung Lee, Hsinchu (TW); Shin-Yao Perng, Hsinchu (TW)

Correspondence Address: APEX JURIS, PLLC, 12733 LAKE CITY WAY NORTHEAST, SEATTLE, WA, 98125, US

(73) Assignee: MITAC TECHNOLOGY CORP., Hsinchu (TW)

(21) Appl. No.: 12/200,382

(22) Filed: Aug. 28, 2008

(51) Int. Cl. H04Q 5/22

(52) U.S. Cl. 340/10.2

(57) ABSTRACT

A method for preventing signal collision in radio frequency identification (RFID) system through random code timing is disclosed. The RFID system includes one or more RFID reading device to receive respective tag information from a plurality of RFID tags. Multiple RFID tags of the RFID system each includes a microprocessor connected to a random code generation unit, a power supply unit, a memory unit and a radio frequency transceiver module. The memory unit stores the respective tag information that contains a tag identification code. The microprocessor of the RFID tag issues a base number or uses the tag identification code to generate a random code and a tag signal is transmitted to the RFID reading device in accordance with the random code so generated.

### FIELD OF THE INVENTION

The present invention relates to wireless communication, in particular, to a method for preventing signal collision in radio frequency identification system through random code timing.

### BACKGROUND OF THE INVENTION

A radio frequency identification (RFID) system is an advanced technique that uses radio waves to transmit data for realizing automatic object identification. The RFID system is generally comprised of two parts: an RFID tag and an RFID reading device or RFID reader.

The RFID tag includes a chip that contains a unique identification (UID) code and an antenna unit, which are properly packed by means of special packaging technique. The RFID can be further divided in two classes, namely active type and passive type, based on the way how energy is supplied. A difference between the active type and the passive type resides in the fact that the active RFID includes a power source, such as a battery, while passive type does not. Due to such a reason that a passive RFID itself does not include a power source, it can only be energized by an RFID reader. An RFID reader is comprised of an antenna, a radio transceiver module, and a data processing module. Generally, the interaction between the RFID reader and the RFID tag includes:

(1) The RFID reader transmits electromagnetic energy through the antenna and the RFID tag receives the electromagnetic energy transmitted from the RFID reader through its own antenna and coverts the electromagnetic energy into electric energy for the operation of the internal chip;

(2) The RFID reader must receive data that is formed by the RFID tag processing internal identification code for identification; and

(3) In case that the RFID tag contains a writable memory, the RFID reader is allowed to transmit data to the RFID tag for data registration.

In applications where the RFID reader has to read multiple RFID tags simultaneously, signal collision may occur among the tag signals read by the RFID reader. If the RFID tags are forced to transmit signals one by one, the signal readability can be enhanced. However, in case when multiple RFID tags simultaneously pass by an RFID reader, handling signal collision becomes an important technique.

Signal collision occurring in an RFID system essentially includes tag signal collision and reader signal collision. The former means an RFID reader simultaneously receive signals returned by multiple RFID tags, making it impossible for the RFID reader to correctly read the signals or even making incorrect determination, while the later is a situation where the same RFID tag receives different instruction from multiple RFID readers, leading to interference. The occurrence of signal collision causes failure and loss of signal transmission and even incorrect interpretation of signal to make incorrect data, both being obstacles for identification operation.

Heretofore, anti-collision is realized by repeated transmission of signal at a time period next to a previous time period when signal collision is expected to occur based on prediction according to probability of collision to thereby ensure the signals transmitted can be all correctly read. Yet, a disadvantage that the total time required to read all the RFID tags are extended may be encountered.

### SUMMARY OF THE INVENTION

To solve the aforesaid problems of the prior art, the present invention provides a method for a method for preventing signal collision in RFID (radio frequency identification system) through random code timing. A random code generated by a RFID tag is used to generate a time shift along a time axis based on the random code. Therefore in accordance with the time shift, the RFID tag can transmit tag signals to a RFID reading device through random code timing.

In one aspect of the present invention, a method is provided to prevent a signal collision in a RFID system. The RFID system includes at least one RFID reading device that comprises a microprocessor connected to a radio frequency transceiver module for receiving respective tag information from a plurality of RFID tags. The RFID tags each comprises a microprocessor connected to a memory unit and a radio frequency transceiver module; wherein the memory unit stores the respective tag information. The method comprising the following steps: (a) the RFID tag generates a random code; (b) the microprocessor of the RFID tag generates a time shift along a time axis based on the random code; (c) the RFID tag transmits a tag signal containing the tag information in accordance with the time shift; and (d) the RFID reading device receives the tag signal of the RFID tag.

In another aspect of the present invention, a method with the following steps is provided to prevent a signal collision in a RFID system. (a) The microprocessor of the RFID tag retrieves the tag information from the memory unit and basing on the tag information to generate a random code; (b) the RFID tag transmits a tag signal containing the tag information in accordance with the random code; and the RFID reading device receives the tag signal of the RFID tag.

In another aspect of the present invention, A RFID tag comprises a microprocessor, a random code generation unit, a power supply unit, a memory unit and a radio frequency transceiver module. The random code generation unit is connected to the microprocessor for generating a random code. The power supply unit connects to the microprocessor for supplying power to the microprocessor. The memory unit connects to the microprocessor for storing tag information. The radio frequency transceiver module is connected to the microprocessor for receiving and transmitting radio frequency signal; wherein the random code generation unit of the RFID tag generates the random code based on which the microprocessor of the RFID tag generates a time shift in a time axis and wherein the microprocessor transmits the tag information in accordance with the time shift.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will be apparent to those skilled in the art by reading the following description of the best mode for carrying out the present invention, with reference to the attached drawings, in which:

FIG. 1 shows a schematic view of an RFID system in accordance with a first embodiment of the present invention;

FIG. 2 shows a system block diagram constituted by the components of the first embodiment of the present invention;

FIG. 3 shows a flow chart in accordance with the first embodiment of the present invention;

FIG. 4 shows a timing chart that indicates packet transmission timing sequence between RFID tags and a RFID reading device of the first embodiment of the present invention;

FIG. 5 shows a timing chart that indicates RFID tag transmit packets for multiple times in accordance with the first embodiment of the present invention;

FIG. 6 shows a flow chart in accordance with a second embodiment of the present invention;

FIG. 7 shows a timing chart that indicates RFID tags successively transmit packets in accordance with a third embodiment of the present invention; and

FIG. 8 shows a flow chart in accordance with the third embodiment of the present invention.

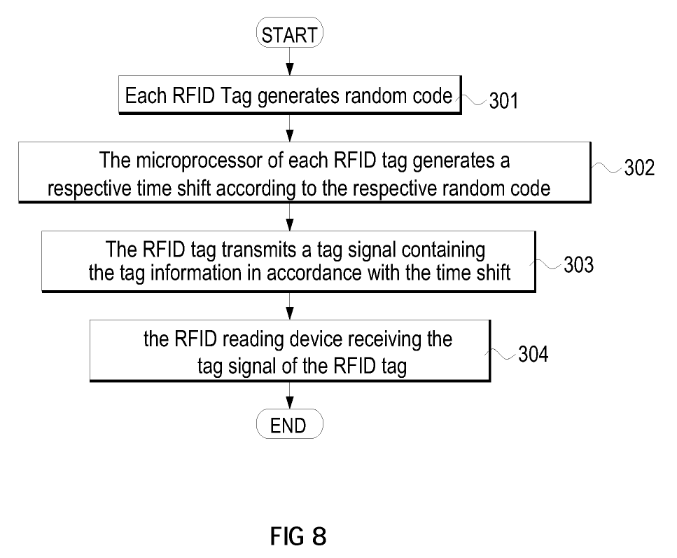

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description refers to the same or the like parts.

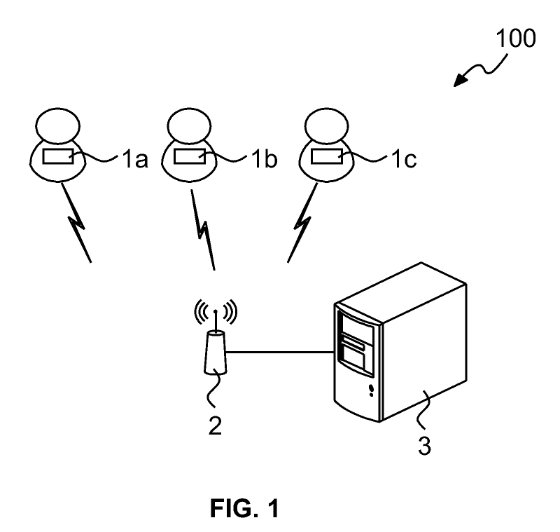

With reference to FIG. 1, which shows a schematic view of a radio frequency identification (RFID) system in accordance with a first embodiment of the present invention, as shown in the drawings, an RFID system 100 comprises a plurality of RFID tags 1a, 1b, 1c, a RFID reading device 2. The RFID reading device 2 serves to receive information contained in each RFID tag 1a, 1b, 1c and the RFID reading device 2 is connected to a host control device 3 for transmitting the received information to the host control device 3. In the instant embodiment, three RFID tags 1a, 1b, 1c are taken as an example, yet those skilled in the art can appreciate that the number of the RFID tags is not limited to this example.

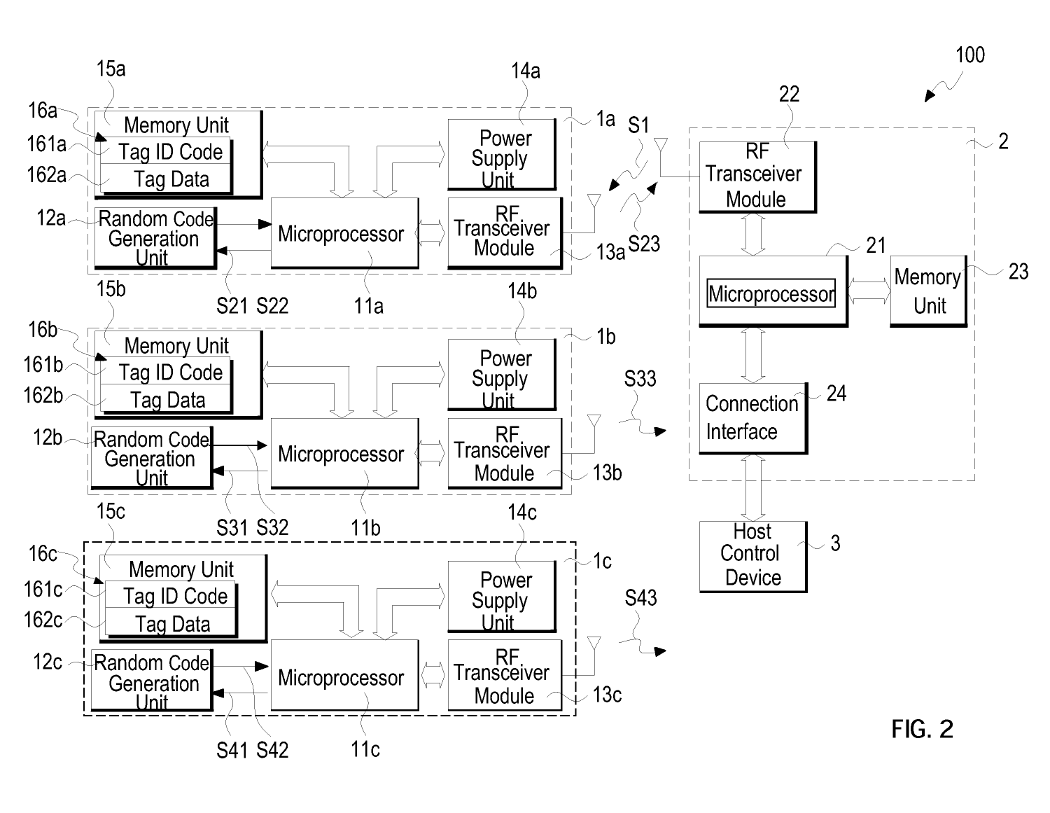

Referring to FIG. 2, which shows a system block diagram constituted by the components of the first embodiment of the present invention, as shown, the RFID tag 1a comprises a microprocessor 11a, which is connected to a random code generation unit 12a, a radio frequency transceiver module 13a, and a power supply unit 14a. The microprocessor 11a is connected to a memory unit 15a, which stores tag information 16a. The tag information 16a includes a tag identification code 161a and tag data 162a, wherein the tag identification code 161a is unique and non-repeated and can be used as identification for the RFID tag 1a.

Similarly, the RFID tag 1b comprises a microprocessor 11b, which is connected to a random code generation unit 12b, a radio frequency transceiver module 13b, and a power supply unit 14b. The microprocessor 11b is connected to a memory unit 15b, which stores tag information 16b. The tag information 16b includes a tag identification code 161b and tag data 162b, wherein the tag identification code 161b is unique and non-repeated and can be used as identification for the RFID tag 1b.

Similar to the previous two RFID tags, the RFID tag 1c comprises a microprocessor 11c, which is connected to a random code generation unit 12c, a radio frequency transceiver module 13c, and a power supply unit 14c. The microprocessor 11c is connected to a memory unit 15c, which stores tag information 16c. The tag information 16c includes a tag identification code 161c and tag data 162c, wherein the tag identification code 161c is unique and non-repeated and can be used as identification for the RFID tag 1c.

The RFID tags 1a, 1b, 1c of the instant embodiment are active type RFID tags, and the tag data 162a, 162b, 162c contains all sort of related information/data, such as data of available tag power (which can be employed to evaluate residual of power), data of tag mode (which can be used to determine a sleeping mode or an operation mode), data of firmware version (which can be used to update version of firmware), data of software version (which can be used to update version of software), data of transmission bandwidth (which can be used to determine the frequency), data of transmission power (which can be used to determine transmission power), data of authenticity (which can be used to filter out counterfeit tags), data of tag owner (which indicates the owner of the tag), and data of tag group (which indicates the department to which the tag belongs).

The RFID reading device 2 comprises a microprocessor 21, which is connected to a RF (radio frequency) transceiver module 22, a memory unit 23, and a connection interface 24. The radio frequency transceiver module 22 serves to receive tag information 16a, 16b, 16c from the RFID tag 1a, 1b, 1c and is connected, through the connection interface 24, to the host control device 3 for transmitting the received information to the host control device 3.

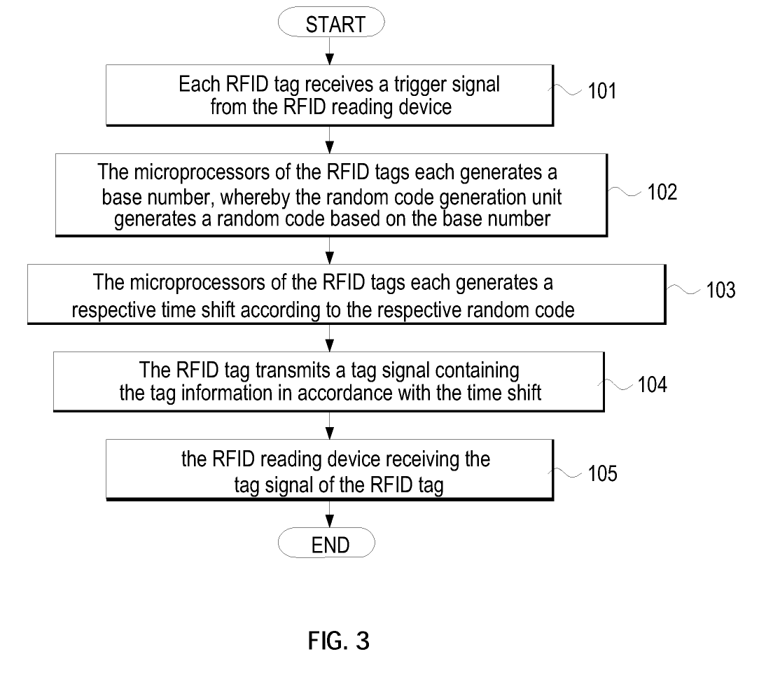

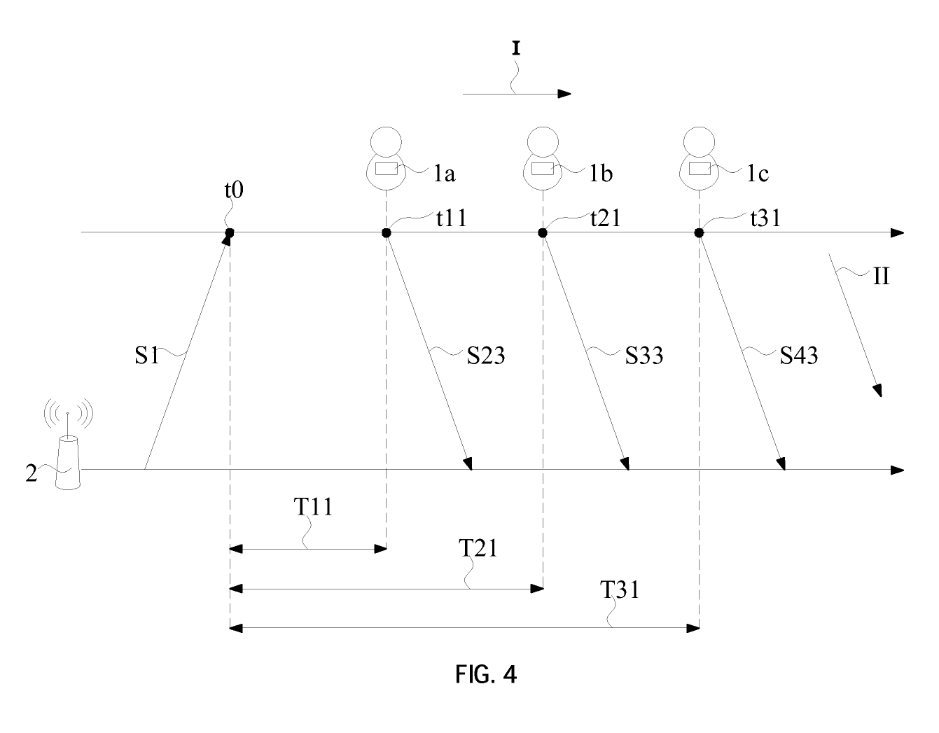

Referring to FIGS. 3 and 4, which respectively show a flow chart in accordance with the first embodiment of the present invention and a timing chart that indicates packet transmission timing sequence between each RFID tag and the RFID reading device of the first embodiment, firstly, each RFID tag 1a, 1b, 1c receives a trigger signal S1 from the RFID reading device 2 (step 101), wherein the time point when the RFID tags 1a, 1b, 1c simultaneously receive the trigger signal S1 is set as time point t0. At this time, under the control of the microprocessors 11a, 11b, 11c of the RFID tags 1a, 1b, 1c, the microprocessors 11a, 11b, 11c each generates a base number and transmits a first signal S21, S31, S 41 that contains the base number to the random code generation units 12a, 12b, 12c respectively, whereby the random code generation units 12a, 12b, 12c each base on the respective base number to generate a random code (step 102).

The random code can be generated in various ways, of which a linear congruential generator (LCG) is taken as an example in the instant embodiment to generate a pseudo-random number, which is then used as the random code. The LCG bases on the following recursive formula:

Xₙ₊₁=(a Xₙ+c) mod(m)

wherein a, c, and m are all integers and are subject to the following conditions:

(a) 0<m, modulus;

(b) 0≦a<m, multiplier;

(c) 0≦c<m, increment; and

(d) 0≦X₀<m, seed.

In the generation of the random code, a large integer m is first picked and the above recursive formula is taken to generate a series of integers between 0 and m−1. The seed value X₀ is defined by the base number generated by the microprocessor 11a, 11b, 11c and the other numbers are generated with the above formula on the basis of the seed X₀. The random code is obtained by normalizing the numbers to be in the range of 0 to 1. In other word, with Rₙ indicating the random code, then Rₙ=Xₙ/M for all n's.

Thereafter, the microprocessor 11a, 11b, 11c of each RFID tag 1a, 1b, 1c receives a respective second signal S22, S32, S42 that contains the respective random code and generates a respective time shift T11, T21, T31 on the time axis in the time axis direction I in accordance with the respective random code (step 103). The time shifts T11, T21, T31 correspond to the RFID tags 1a, 1b, 1c respectively and since the time shifts T11, T21, T31 are each generated on the basis of the respective random code, they are of different lengths, as illustrated in FIG. 4.

The RFID tags 1a, 1b, 1c then transmit tag signals S23, S33, S43 that contain the tag information 16a, 16b, 16c respectively at time points t11, t21, t31 determined by the time shifts T11, T21, T31 (step 104). Finally, the RFID reading device 2 receives the tag signal S23, S33, S43 of each RFID tag 1a, 1b, 1c in a signal transmission direction II (step 105).

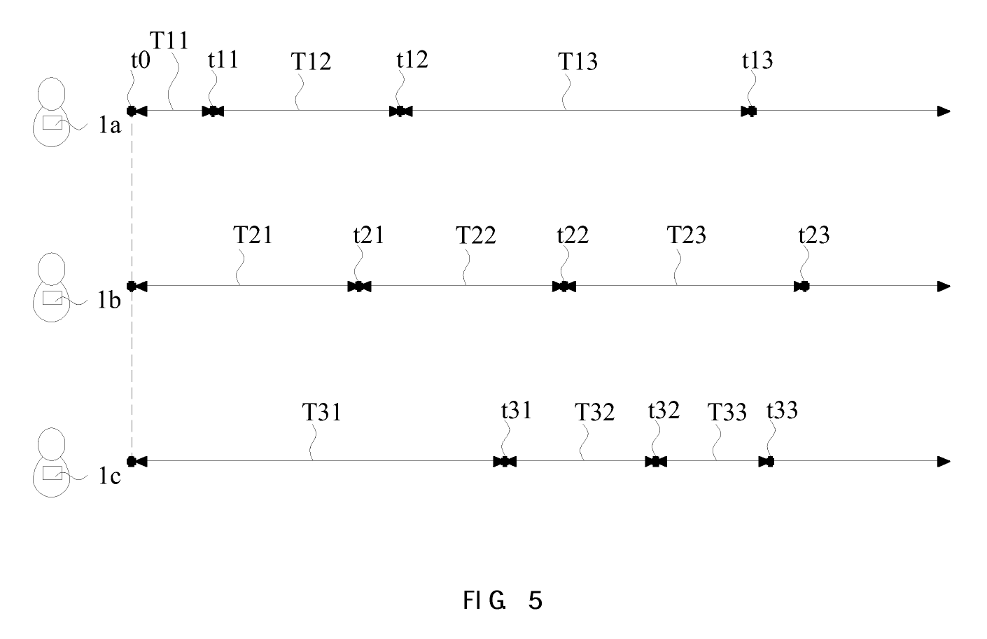

Referring to FIG. 5, which shows a timing chart that indicates that each RFID tag transmits packets for multiple times in accordance with the first embodiment, in accordance with the first embodiment, each RFID tag 1a, 1b, 1c, after receiving the trigger signal S1 from the RFID reading device 2 at the first time, generates a time shift T11, T21, T31 in accordance with the respective random code and transmits signals at the time point t11, t21, t31. Then, at the second time that the RFID tag 1a, 1b, 1c receives the trigger signal S1, a time shift T12, T22, T32 is generated and a signal is transmitted at a corresponding time point t12, t22, t32. Similarly, at the third time that the RFID tag 1a, 1b, 1c receives the trigger signal S1, a time shift T13, T23, T33 is generated and a signal is transmitted at a corresponding time point t13, t23, t33. Understandably, each time shift of each RFID tag 1a, 1b, 1c is determined by the generation of a random code and thus, each time point that is set for each RFID tag 1a, 1b, 1c is different, whereby signal collision among the RFID tags 1a, 1b, 1c can be effectively avoided.

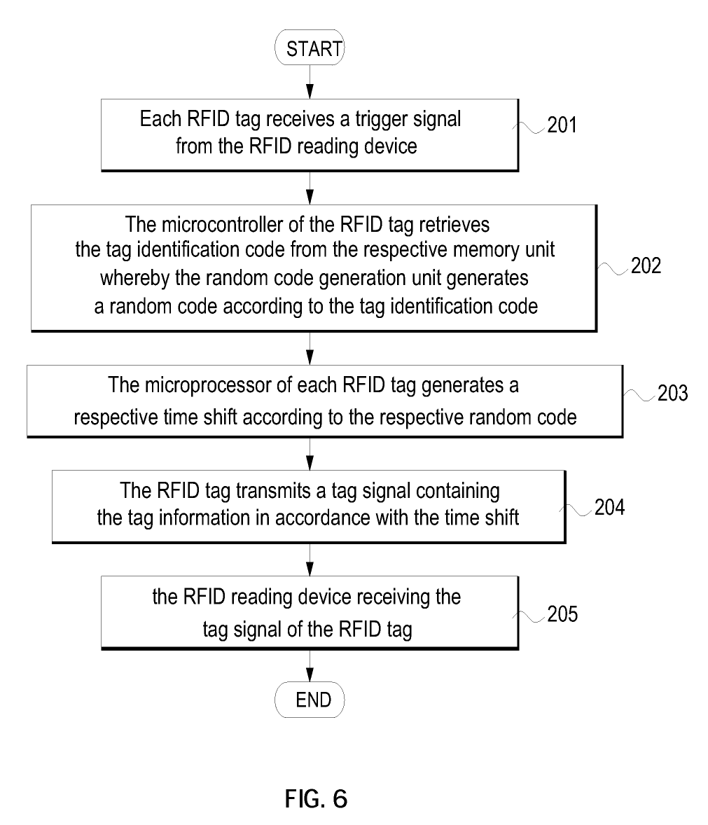

Referring to FIG. 6, which shows a flow chart in accordance with the second embodiment of the present invention, in the second embodiment, the RFID tags are of the same construction as those of the first embodiment and are passive type RFID tags. The operation process is substantially identical to that of the first embodiment, but with a different way of random code generation employed.

Firstly, each RFID tag 1a, 1b, 1c receives a trigger signal S1 from the RFID reading device 2 (step 201). Under the control of the microprocessors 11a, 11b, 11c of the RFID tags 1a, 1b, 1c, the microprocessors 11a, 11b, 11c each retrieve the tag identification (ID) code 161a, 161b, 161c of the respective memory unit 15a, 15b, 15c and the random code generation unit 12a, 12b, 12c generates a random code in accordance with the tag identification code 161a, 161b, 161c (step 202). In other words, the tag identification code 161a, 161b, 161c (which is often the second digit of the ID number) is used to define the seed value X₀ of the recursive formula of the previously mentioned LCG and then the random code can be obtained.

The microprocessor 11a, 11b, 11c of each RFID tag 1a, 1b, 1c receives a respective second signal S22, S32, S42 that contains the respective random code and generates a respective time shift T11, T21, T31 on the time axis in the time axis direction I in accordance with the respective random code (step 203). Similar to the first embodiment, the time shifts T11, T21, T31 correspond to the RFID tags 1a, 1b, 1c respectively and since the time shifts T11, T21, T31 are each generated on the basis of the respective random code that corresponds to tag identification code 161a, 161b, 161c of the RFID tag 1a, 1b, 1c, they are of different lengths, as illustrated in FIG. 4.

The subsequent procedure is identical to the previously described. The RFID tags 1a, 1b, 1c transmit tag signals S23, S33, S43 that contain the tag information 16a, 16b, 16c respectively according to the time shifts T11, T21, T31 (step 204). Finally, the RFID reading device 2 receives the tag signal S23, S33, S43 of each RFID tag 1a, 1b, 1c in a signal transmission direction II (step 205).

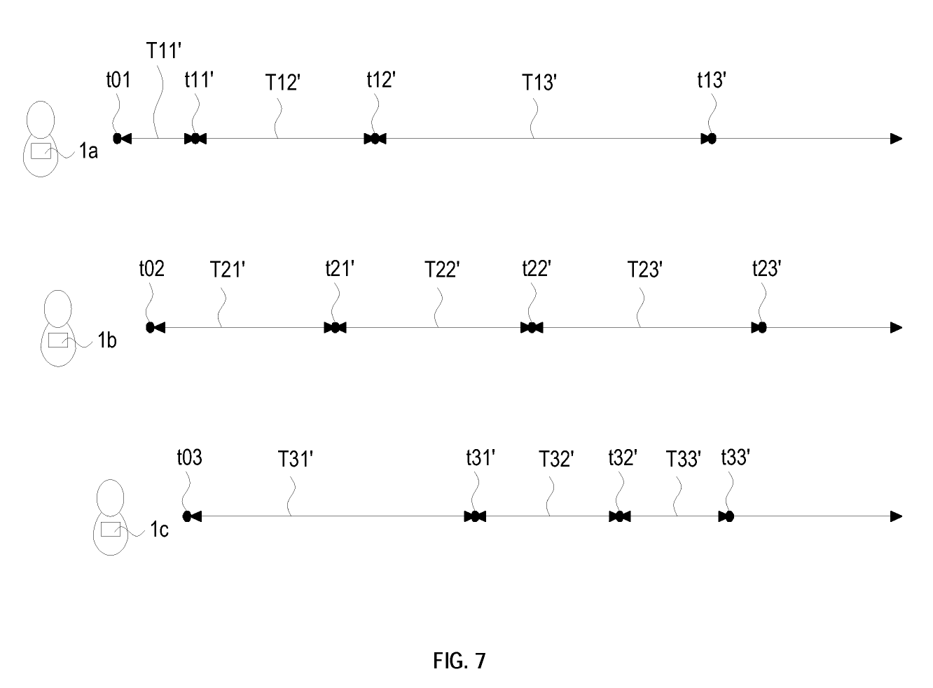

Referring to FIG. 7, which shows a timing chart that indicates that each RFID tag successively transmits packets in accordance with the third embodiment, in the instant embodiment, each RFID tag 1a, 1b, 1c is an active type RFID tag and thus no wake-up is necessary in carrying out successive transmission of signal.

As shown in the drawing, the instant embodiment is similar to those previous embodiments, but since the RFID tags 1a, 1b, 1c of the instant embodiment are active type, which allows successive transmission of signals. A time point when the RFID tag 1a, 1b, 1c starts to transmit signals is set as t01, t02, t03.

Firstly, each RFID tag 1a, 1b, 1c generates a random code (step 301). The generation of the random code is the same as that of the previous embodiments and can be generated by the random code generation unit on the basis of the base number generated by the microprocessor or the respective tag identification code.

Each RFID tag 1a, 1b, 1c bases on the respective random code to generate a respective time shift T11′, T21′, T31′ on the time axis (step 302), and transmits a signal at a corresponding time point t11′, t21′, t31′. Similarly, another time shift T13′, T23′, T33′ is generated and a tag signal containing tag information is transmitted at a corresponding time point t13′, t23′, t33′ (step 303).

The RFID reading device then receives the tag signal of each RFID tag 1a, 1b, 1c (step 304). Understandably, each time shift of each RFID tag 1a, 1b, 1c is determined by the generation of a random code and thus, each time point that is set for each RFID tag 1a, 1b, 1c is different. Consequently, signal collision occurring among the RFID tags 1a, 1b, 1c in signal transmission can be effectively avoided.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A method to prevent a signal collision in a RFID (radio frequency identification) system, the RFID system comprising at least one RFID reading device that comprises a microprocessor connected to a radio frequency transceiver module for receiving respective tag information from a plurality of RFID tags, the RFID tags each comprising a microprocessor connected to a memory unit and a radio frequency transceiver module, wherein the memory unit stores the respective tag information, the method comprising the steps of:
(a) the RFID tag generating a random code;
(b) the microprocessor of the RFID tag generating a time shift along a time axis based on the random code;
(c) the RFID tag transmitting a tag signal containing the tag information in accordance with the time shift; and
(d) the RFID reading device receiving the tag signal of the RFID tag.

2. The method as claimed in claim 1, wherein in step (a), the generation of the random code is that the microprocessor generates a base number and a random code generation unit generates the random code in accordance with the base number under the control of the microprocessor.

3. The method as claimed in claim 1, wherein before step (a), a step that the RFID tag receives a trigger signal from the RFID reading device is further included.

4. The method as claimed in claim 1, wherein the tag information contains a tag identification code.

5. The method as claimed in claim 1, wherein the tag information contains a tag data, which selectively consists of data of available tag power, data of tag mode, data of firmware version, data of software version, data of transmission bandwidth, data of transmission power, data of authenticity, data of tag owner, and data of tag group, or any combination thereof.

6. A method to prevent a signal collision in a RFID (radio frequency identification) system, wherein the RFID system comprises at least one RFID reading device that comprises a microprocessor connected to a radio frequency transceiver module for receiving respective tag information from a plurality of RFID tags, each of the RFID tags comprising a microprocessor connected to a memory unit and a radio frequency transceiver module, wherein the memory unit stores the respective tag information, the method comprising the steps of:
(a) the microprocessor of the RFID tag retrieving the tag information from the memory unit and basing on the tag information to generate a random code;
(b) the RFID tag transmitting a tag signal containing the tag information in accordance with the random code; and
(c) the RFID reading device receiving the tag signal of the RFID tag.

7. The method as claimed in claim 6, wherein before step (a), a step that the RFID tag receives a trigger signal from the RFID reading device is further included.

8. The method as claimed in claim 6, wherein the tag information contains a tag identification code.

9. The method as claimed in claim 6, wherein the tag information contains a tag data, which selectively consists of data of available tag power, data of tag mode, data of firmware version, data of software version, data of transmission bandwidth, data of transmission power, data of authenticity, data of tag owner, and data of tag group, or any combination thereof.

10. The method as claimed in claim 6, wherein in step (a), the microprocessor of the RFID tag generates a time shift along a time axis based on the random code.

11. The method as claimed in claim 10, wherein in step (b), the RFID tag transmits the tag signal in accordance with the time shift.

12. A RFID (radio frequency identification) tag, comprising:
a microprocessor;
a random code generation unit connected to the microprocessor for generating a random code;
a power supply unit connected to the microprocessor for supplying power to the microprocessor;
a memory unit connected to the microprocessor for storing tag information; and
a radio frequency transceiver module connected to the microprocessor for receiving and transmitting radio frequency signal;
wherein the random code generation unit of the RFID tag generates the random code based on which the microprocessor of the RFID tag generates a time shift in a time axis and wherein the microprocessor transmits the tag information in accordance with the time shift.

13. The RFID tag as claimed in claim 12, wherein the tag information contains a tag identification code.

14. The RFID tag as claimed in claim 12, wherein the tag information contains a tag data, which selectively consists of data of available tag power, data of tag mode, data of firmware version, data of software version, data of transmission bandwidth, data of transmission power, data of authenticity, data of tag owner, and data of tag group, or any combination thereof.
